(19) United States
(12) Patent Application Publication
(10) Pub. No.: US 2023/0252012 A1
(43) Pub. Date: Aug. 10, 2023

(54) METHOD FOR INDEXING DATA

(71) Applicant: TmaxTibero Co., Ltd., Seongnam-si (KR)

(72) Inventors: Seungmin LEE, Seongnam-si (KR); Hyunwook KIM, Yongin-si (KR); Stellar HEO, Seongnam-si (KR); Sangyoung PARK, Seoul (KR)

(21) Appl. No.: 17/984,980

(22) Filed: Nov. 10, 2022

(30) Foreign Application Priority Data
Feb. 9, 2022 (KR) 10-2022-0016811

(51) Int. Cl. G06F 16/22; G06F 16/23; G06F 16/2453; G06F 11/34

(52) U.S. Cl. CPC G06F 16/2246; G06F 16/2343; G06F 16/2453; G06F 11/3409

(57) ABSTRACT

Disclosed is a data indexing method performed by a computing device. The data indexing method includes acquiring data structures of a variable size that defines a range of key values of a plurality of nodes included in a tree structure, the data structure of one variable size corresponding to one node. The method includes acquiring a lock for some nodes of the plurality of nodes included in the tree structure and performing a computation or a split operation.

### CROSS-REFERENCE TO RELATED APPLICATIONS

This application claims priority to and the benefit of Korean Patent Application No. 10-2022-0016811 filed in the Korean Intellectual Property Office on Feb. 9, 2022, the entire contents of which are incorporated herein by reference.

### BACKGROUND

### Technical Field

The present disclosure relates to an information processing field, and more particularly, to a method of indexing data.

### Description of the Related Art

With the recent development of information and communication technology, vast amounts of data are being generated not only in businesses and governments, but also in daily life. Research and development on a method of processing such a large amount of data more quickly and accurately is also a trend. In addition, research and development on how to operate a database, which is a set of data integrated and managed for the purpose of sharing and using data, is also being conducted. The method of structuralizing and storing the data of the database may affect the search for data and the operation and processing of data.

Corporate business is rapidly expanding due to the explosive increase of data and the emergence of various environments and platforms. With an advent of a new business environment, more efficient and flexible data services, information processing, and data management functions are required. In line with these changes, research on databases to solve the problems of high performance, high availability, and scalability, which are the basis of corporate business implementation, is continuing.

In a database management system (DBMS), data may be stored in a data storage. In a relational database management system (RDBMS), the data storage may be referred to as a table. The table may include one or more rows, and each of the one or more rows may include one or more columns.

### PRIOR ART LITERATURE

### Patent Document

(Patent Document 1) Korean Patent Application Laid-Open No. 10-2019-0079354

### BRIEF SUMMARY

The inventors have realized that when the database includes a large amount of data, it may take a relatively long time to perform a query to retrieve data that a user is interested in. When it takes a long time for the database to respond to queries, the performance of the database may be adversely affected. Accordingly, one or more embodiments of the present disclosure provide example structures and methods to reduce the processing time for responding to a query, that is, to increase the performance of a database management system.

In increasing the speed of data retrieval from a database, an indexing technique may be utilized. The index may mean a data structure that increases the operation speed of a table in the database field. When an index is used, not only the time required for data retrieval may be reduced, but also the amount of resources consumed for data retrieval may be reduced.

As described above, the relational database uses an index structure for efficient data search. Among the index structures used, the structure that indexes spatial data is called R-Tree. Spatial data is characterized by values in the form of a multidimensional range. The R-tree index is a structure that refers to a form and a modification method for maintaining a tree structure in consideration of the above-described characteristics. One or more embodiments of the present disclosure provides an efficient way of retrieving data using various concepts including the aforementioned concepts.

One or more embodiments of the present disclosure efficiently indexes data in an environment in which a large amount of data is simultaneously and rapidly changing.

The technical benefits of the present disclosure are not limited to the foregoing technical benefits, and other non-mentioned technical benefits will be clearly understood by those skilled in the art from the description below.

In order to address the various technical problems in the related art, an example embodiment of the present disclosure discloses is a data indexing method performed by a computing device, the data indexing method including: acquiring data structures of a variable size that defines a range of key values of a plurality of nodes included in a tree structure, the data structure of one variable size corresponding to one node; and acquiring a lock for some nodes of the plurality of nodes included in the tree structure and performing a computation or a split operation.

In the example embodiment, the data structure of the variable size may include a rectangular data structure including key values of child nodes or key values of data, the data structure may include a first data structure corresponding to a first upper node among the plurality of nodes and a second data structure corresponding to a second lower node of at least one of lower nodes included in the first upper node, and a range of the first data structure may include a portion, but not all, of a range of the second data structure.

In the example embodiment, the performing of the computation or the split operation on at least one node in the tree structure may include: recording information for each node included in the tree structure into a corresponding node, and the information for each node includes at least one of child node information, a starting time and a final modification time of the computation when the operation is performed, and includes at least one of an address, a key value, and the number of times of the split of a node generated by the split operation when the split operation is performed.

In the example embodiment, the acquiring of the lock for some nodes of the plurality of nodes and the performing of the computation or the split operation may include acquiring an individual lock of a node to be visited to perform the computation or the split operation, updating or extending a key value and a data structure of the visited node, and releasing the acquired individual lock.

In the example embodiment, the acquiring of the lock for some nodes of the plurality of nodes and the performing of the computation or the split operation may include: acquiring, from a memory, records of nodes visited to perform the computation or the split operation; and acquiring a lock for some of the plurality of nodes based on the records of the visited nodes, and performing a corresponding computation or a split operation.

In the example embodiment, an individual lock for a branch node may be acquired in the computation, and the individual lock may continue for a modification time for the branch node.

In the example embodiment, the computation may include at least one of: a first computation of searching for a first data corresponding to a first key value and a first time point included in the tree structure; a second computation of inserting a second key value and a second data address corresponding to second data into a second node of the tree structure; a third computation of deleting a third key value and a third data address corresponding to third data from a third node of the tree structure; and a fourth computation of, when a range of key values included in a fourth node is equal to or less than a preset threshold range or when the number of keys included in the fourth node is equal to or less than a preset threshold number, removing the fourth node or merging the fourth node to another node.

In the example embodiment, the second computation may include, when a second key value corresponding to the second data is inserted, determining the second node that satisfies a condition in which key values of ancestor nodes to be modified are not changed or a condition in which a range of key values is changed to a minimum as a node into which the second key value is to be inserted.

In the example embodiment, the second computation may further include: for each of the ancestor nodes to go through to visit the second node, acquiring an individual lock for a first ancestor node to be visited among the ancestor nodes, and modifying a key value for the first ancestor node on the assumption that a second key value corresponding to the second data is to be inserted into the second node; and releasing the lock acquired for the first ancestor node when the modification of the key value for the first ancestor node is completed.

In the example embodiment, the second computation may include modifying a key value of a parent node of the second node before modifying a second key value of the second node that is a leaf node.

In the example embodiment, the second computation may include: acquiring a second time point, which is a time point at which searching of the tree structure starts to perform the second computation; acquiring a final modification time of the second node based on information for each node corresponding to the second node; comparing the second time point with the final modification time of the second node and re-executing the second computation when the final modification time is more recent; and comparing the second time point and the final modification time of the second node, and when the second time point is more recent, inserting a second key value corresponding to the second data into the second node, and updating the final modification time of the second node to a corresponding time point.

In the example embodiment, the second computation may include: determining a second node into which a second key value corresponding to the second data is to be inserted; checking whether there is a space for inserting a new value in the second node; inserting the second key value into the second node when there is space in the second node to insert the new value; and performing a split operation when the space for inserting the new value is insufficient in the second node, and inserting the second key value into the second node or a new node generated according to the split operation, and the split operation may include acquiring information for each node including the number of time so the split of the node and acquiring a visit log of the second node including information on ancestor nodes visited to search for the second node.

In the example embodiment, the split operation may further include: visiting a parent node of the second node based on the visit log and acquiring an individual lock for the visited parent node; acquiring a first number of times of the split of the parent node at a start time point of the split operation based on the information for each node, acquiring a second number of times of the split recorded in the visited parent node, and comparing the first number of times of the split with the second number of times of the split; when the first number of times of the split matches the second number of times of the split, performing splitting, inserting a new key value according to a result of the splitting into the parent node, and releasing the acquired individual lock; and re-executing the split operation without performing the splitting when the first number of times of the split and the second number of times of the split do not match.

In the example embodiment, the third computation may include: acquiring a visit log including information on ancestor nodes visited to search for the third node; visiting a third ancestor node among the ancestor nodes of the third node based on the visit log, and acquiring child node information of the third ancestor node at a third time point at which the third ancestor node is visited; after visiting a child node of the third ancestor node, revisiting the third ancestor node and acquiring child node information at a fourth time point at which the third ancestor node is revisited; and comparing the child node information at the third time point with the child node information at the fourth time point.

In the example embodiment, the third computation may further include: when the child node information at the third time point matches the child node information at the fourth time point, deleting a third key value corresponding to the third data; and when the child node information at the third time point and the child node information at the fourth time point do not match and it is determined that a newly added child node exists, recording the newly added child node in the third ancestor node.

In the example embodiment, in the third computation, an individual lock for the third ancestor node may be acquired, and the individual lock for the third ancestor node may be maintained while visiting the third ancestor node to acquire the child node information of the third ancestor node.

In the example embodiment, the fourth computation may include at least one of: removing the fourth node or a fourth key value corresponding to the fourth node when the number of keys included in the fourth node is 0; when the number of keys included in the fourth node is not 0 and is equal to or less than a preset threshold number, merging a fourth key value of the fourth node with a sibling node in which the expansion of the data structure is minimal—the sibling node is a sibling node of the fourth node; and updating a key value of each of the plurality of nodes to a minimum circumscribed rectangle including only key values of child nodes.

In the example embodiment, the removing of the fourth node or the key value corresponding to the fourth node when the number of keys included in the fourth node is 0 may include acquiring a lock for the fourth node and a parent node of the fourth node, removing a key value corresponding to the fourth node from the parent node of the fourth node, and releasing the acquired lock.

In the example embodiment, the merging of the fourth key value of the fourth node with the sibling node in which an expansion of a data structure is minimal may include: acquiring a lock of the fourth node and a parent node of the fourth node; checking information for each node of the parent node of the fourth node, and when it is determined that key values of the fourth node are included in the parent node, selecting the sibling node in which the expansion of the data structure is reduced or minimized and acquiring a lock for the selected sibling node; and releasing locks for the fourth node, the parent node of the fourth node, and the sibling node when the transfer of all key values of the fourth node to the sibling node is finished.

In the example embodiment, the updating of the key value of each of the plurality of nodes to the minimum circumscribed rectangle including only the key values of the child nodes may include: acquiring a lock of the fourth node and a parent node of the fourth node; when the range of key values of the fourth node is compared with a range of key values of the parent node of the fourth node and a criterion of the minimum circumscribed rectangle is not satisfied, updating the key value of at least one of the fourth node and the parent node such that the corresponding range of the key values of the fourth node and the parent node satisfies a criterion of the minimum circumscribed rectangle; and after updating the key values, releasing the locks acquired for the fourth node and the parent node of the fourth node.

In order to address the various technical problems in the related art, another example embodiment of the present disclosure discloses is a non-transitory computer readable medium including a computer program, the computer program causing at least one processor of a computing device to perform a data indexing method, the data indexing method comprising: acquiring data structures of variable sizes defining a range of key values of a plurality of nodes included in a tree structure, one data structure of the variable size corresponding to one node; and acquiring a lock on some nodes among the plurality of nodes included in the tree structure and performing a computation or a split operation.

In order to solve the foregoing object, another example embodiment of the present disclosure discloses is a computing device including a memory and at least one processor, in which said at least one processor acquires data structures of variable sizes defining a range of key values of a plurality of nodes included in a tree structure, one data structure of the variable size corresponding to one node; and acquires a lock on some nodes among the plurality of nodes included in the tree structure and performs a computation or a split operation.

According to the method according to the example embodiment of the present disclosure, it is possible to index data efficiently in an environment in which queries are simultaneously processed.

The additional scope of applicability of the present disclosure will become apparent from the detailed description which follows. However, various changes and modifications within the spirit and scope of the present disclosure may be clearly understood by those skilled in the art, and it should be understood that the detailed description and specific example embodiments, such as the example embodiments of the present disclosure, are given by way of example only.

### BRIEF DESCRIPTION OF THE SEVERAL VIEWS OF THE DRAWINGS

Various aspects are described with reference to the drawings, and herein, like reference numerals are generally used to designate like constituent elements. In the example embodiment below, for the purpose of description, a plurality of specific and detailed matters is suggested in order to provide general understanding of one or more aspects. However, it is apparent that the aspect(s) may be carried out without the specific and detailed matters.

FIG. 1 is a block diagram illustrating an example of a computing device indexing data according to some example embodiments of the present disclosure.

FIG. 2 is a flowchart of an example of a method of indexing data by the computing device according to some example embodiments of the present disclosure.

FIG. 3 is a diagram illustrating an example of an operation of acquiring a data structure for indexing data according to some example embodiments of the present disclosure.

FIG. 4 is a diagram illustrating an example of an operation of indexing data according to some example embodiments of the present disclosure.

FIG. 5 is a flowchart of an example of a method of indexing data by a computing device according to some example embodiments of the present disclosure.

FIG. 6 is a flowchart of an example of a method of indexing data by a computing device according to some example embodiments of the present disclosure.

FIG. 7 is a flowchart of an example of a method of indexing data by a computing device according to some example embodiments of the present disclosure.

FIG. 8 is a flowchart of an example of a method of indexing data by a computing device according to some example embodiments of the present disclosure.

FIG. 9 is a simple and general schematic diagram illustrating an example of a computing environment in which the example embodiments of the present disclosure are implementable.

### DETAILED DESCRIPTION

Various example embodiments and/or aspects are now disclosed with reference to the drawings. In the description below, the plurality of particular detailed matters are disclosed for helping general understanding of one or more aspects for the purpose of description. However, the point that the aspect(s) is executable even without the particular detailed matters may also be recognized by those skilled in the art. The subsequent description and the accompanying drawings describe specific illustrative aspects of one or more aspects in detail. However, the aspects are illustrative, and some of the various methods of various aspects of the principles may be used, and the descriptions intend to include all of the aspects and the equivalents thereof. In particular, an “example embodiment” an “example,” an “aspect,” an “illustration,” and the like used in the present specification may not be construed to be better or have an advantage compared to a predetermined described aspect, an aspect having a different design, or designs.

Hereinafter, the same or similar constituent element is denoted by the same reference numeral regardless of a reference numeral, and a repeated description thereof will be omitted. Further, in describing the example embodiment disclosed in the present disclosure, when it is determined that a detailed description relating to well-known functions or configurations may make the subject matter of the example embodiment disclosed in the present disclosure unnecessarily ambiguous, the detailed description will be omitted. Further, the accompanying drawings are provided for helping to easily understand example embodiments disclosed in the present specification, and the technical spirit disclosed in the present specification is not limited by the accompanying drawings.

Although the first, second, and the like are used to describe various elements, these elements are not limited by these terms, of course. These terms are only used to distinguish one component from another. Accordingly, it is a matter of course that the first element mentioned below may be the second element within the spirit of the present disclosure.

Unless otherwise defined, all of the terms (including technical and scientific terms) used in the present specification may be used as a meaning commonly understandable by those skilled in the art. Further, terms defined in a generally used dictionary shall not be construed as being ideal or excessive in meaning unless they are clearly defined specially.

A term “or” intends to mean comprehensive “or” not exclusive “or.” That is, unless otherwise specified or when it is unclear in context, “X uses A or B” intends to mean one of the natural comprehensive substitutions. That is, when X uses A, X uses B, or X uses both A and B, or “X uses A or B” may be applied to any one among the cases. Further, a term “and/or” used in the present specification shall be understood to designate and include all of the possible combinations of one or more items among the listed relevant items.

A term “include” and/or “including” shall be understood as meaning that a corresponding characteristic and/or a constituent element exists, but it shall be understood that the existence or an addition of one or more other characteristics, constituent elements, and/or a group thereof is not excluded. Further, unless otherwise specified or when it is unclear in context that a single form is indicated, the singular shall be construed to generally mean “one or more” in the present specification and the claims.

Terms “information” and “data” used in the present specification may be frequently used to be exchangeable with each other.

An object and effect of the present disclosure and technical configurations for achieving them will be apparent with reference to the example embodiments described below in detail together with the accompanying drawings. In describing the present disclosure, when it is determined that detailed description of known function or configurations unnecessarily obscures the subject matter of the present disclosure, the detailed description may be omitted. Further, the terms used in the description are defined in consideration of the function in the present disclosure and may vary depending on an intention or usual practice of a user or operator.

However, the present disclosure is not limited to the example embodiments disclosed below, but may be implemented in various different forms. However, the present example embodiments are provided only to make the present disclosure complete, and to fully inform the scope of the disclosure to those skilled in the art. Accordingly, the definition should be made based on the content throughout the present specification.

In the present disclosure, a computing device 1000 may be a typical server. Here, the server is a system in which users share network resources, and may be a computing environment which the user borrows as much as needed and is used through the network at a desired time. Systems based on the server include deployment models, such as public cloud, private cloud, hybrid cloud, community cloud, or service models, such as Infrastructure as a Service (IaaS), Platform as a Service (PaaS), Software as a Service (SaaS). However, the computing device 1000 in the present disclosure is not limited to the server-based system, and may be implemented according to an example embodiment of the present disclosure even in a centralized method or an edge computing method. The provision of nutritional information to be described in the present disclosure is performed by the computing device 1000. Additionally, according to an implementation aspect, the computing device 1000 may also be implemented with a user terminal. Throughout the specification, the computing device 1000 may refer to a device that indexes data.

In the present disclosure, the computing device 1000 may mean a database server. The database server may include a DataBase Management System (DBMS) and a persistent storage medium. The DBMS is a program for allowing the computing device 1000 to perform any type of operations of the database, such as retrieving, inserting, modifying, and/or deleting necessary data, and generating an index and accessing the index, and as described above, the DBMS may be implemented by a processor 1100 in a memory 1200 of the computing device 1000.

The persistent storage medium means a non-volatile storage medium, which is capable of continuously storing predetermined data, such as a storage device based on a flash memory and/or a battery-backup memory, as well as a magnetic disk, an optical disk, and a magneto-optical storage device. The persistent storage medium may communicate with the processor 1100 and the memory 1200 of the computing device 1000 through various communication means, such as a communication unit 1300. In an additional example embodiment, the persistent storage medium may be located outside the computing device 1000 and also communicate with the computing device 1000. According to the example embodiment of the present disclosure, the persistent storage medium and the memory may be collectively referred to as a storage unit. In additional embodiments, the persistent storage medium in the present specification may be used interchangeably with the memory 1200.

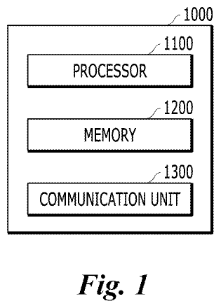

Hereinafter, a method of indexing data by the computing device 1000 will be described in detail with reference to FIG. 1.

FIG. 1 is a block diagram illustrating an example of a computing device indexing data according to some example embodiments of the present disclosure.

Referring to FIG. 1, the computing device 1000 may include a processor 1100, a memory 1200, and a communication unit 1300. However, since the above-described components are not essential in implementing the computing device 1000, the computing device 1000 may include more or fewer components than those listed above.

The processor 1100 according to the example embodiment of the present disclosure may include all types of devices capable of processing operations and data of the computing device 1000 in general. For example, the processor 1100 may refer to a data processing device which has a physically structured circuit to perform a function expressed as a code or an instruction included in a program and is embedded in hardware. Examples of the data processing device embedded in the hardware as described above may include processing devices, such as a microprocessor, a Central Processing Unit (CPU), a processor core, a multiprocessor, an Application-Specific Integrated Circuit (ASIC), and a Field Programmable Gate Array (FPGA), but the scope of the present disclosure is not limited thereto.

For example, the processor 1100 may manage or process data by processing a signal or data input or output through the communication unit 1300 of the computing device 1000 or storing or deleting data in the memory 1200. Specifically, when indexing data, the processor 1100 may acquire a key value and/or an address of data corresponding to the data to be indexed through the communication unit 1300, and generate and/or store information corresponding to the data for indexing necessary for the process of indexing the data. In addition, the processor 1100 may store data for indexing and/or information related to data for indexing in the memory 1200. For example, the memory 1200 may store a data structure including data for indexing, a node included in the data structure, a relationship between nodes, an operation performed to index, and/or information acquired or changed by the operation. In addition, data related to a program for indexing data or cache data may be stored in the memory 1200, but the present disclosure is not limited thereto. That is, the processor 1100 controls the entire process of indexing data including the above process, but the present disclosure is not limited thereto.

In an additional example embodiment of the present disclosure, the memory 1200 may also be included in another computing device (for example, another server or another user terminal) that is separate from the computing device 1000. In this case, the computing device 1000 may communicate with the other computing device to acquire desired data from the memory 1200 included in the other computing device. For example, a database management server (not illustrated) including the memory 1200 may exist separately from the computing device 1000, and the computing device 1000 may acquire data necessary for performing the method according to the example embodiments of the present disclosure from the database management server.

The memory 1200 according to the example embodiment of the present disclosure may include a memory and/or a persistent storage medium. The memory may include at least one type of storage medium among a flash memory type, a hard disk type, a multimedia card micro type, a card type of memory (for example, an SD or XD memory), a Random Access Memory (RAM), a Static Random Access Memory (SRAM), a Read-Only Memory (ROM), an Electrically Erasable Programmable Read-Only Memory (EEPROM), a Programmable Read-Only Memory (PROM), a magnetic memory, a magnetic disk, and an optical disk, but the scope of the present disclosure is not limited thereto.

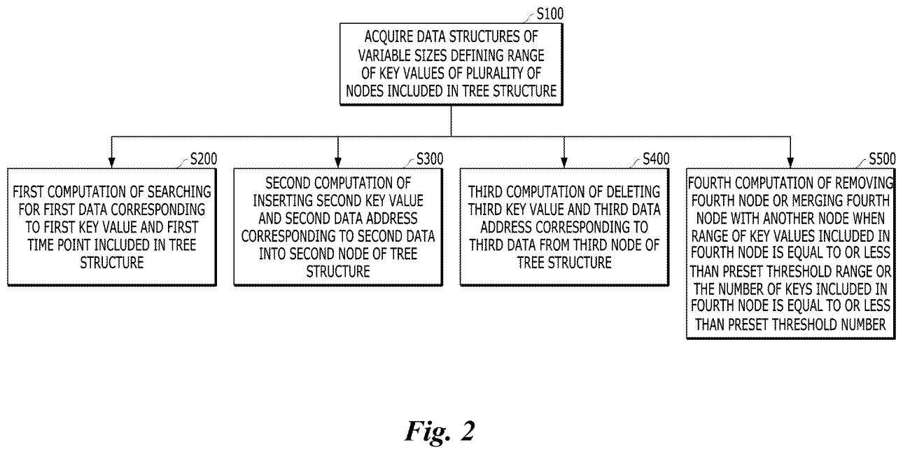

The communication unit 1300 according to the example embodiment of the present disclosure may be configured regardless of the communication mode thereof, such as a wired mode and a wireless mode, and provides a communication interface necessary to provide mutual transmission/reception signals and data between the computing device 1000 and the user terminal and/or a server separate from the computing device 1000 by interworking with a communication network. Specifically, the communication unit 1300 receives data and/or a signal requesting operation on data from the outside of the computing device 1000, and transmits data received as the response and/or another data corresponding to the request, but the present disclosure is not limited thereto. Hereinafter, an example of a method of indexing data by the computing device 1000 according to the present disclosure will be described with reference to FIGS. 2 to 9.

FIG. 2 is a flowchart of an example of a method of indexing data by the computing device according to some example embodiments of the present disclosure.

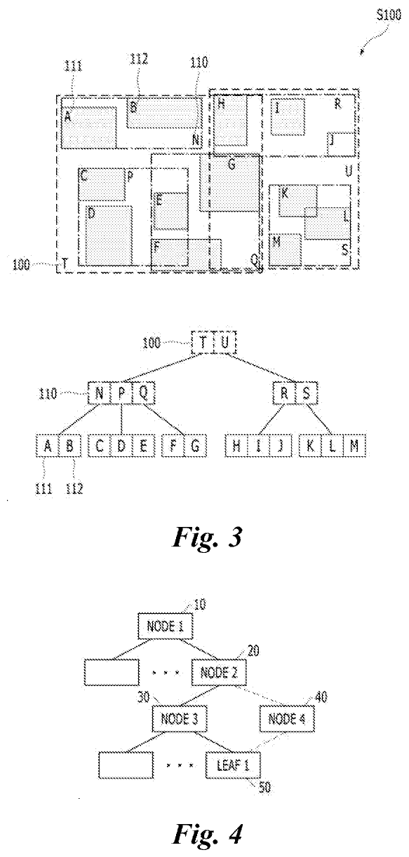

Referring to FIG. 2, in operation S100, the computing device 1000 may acquire a data structure including data for indexing. In the present disclosure, the data structure may mean a data structure of a variable size that defines and includes a range of key values of a plurality of nodes included in a typical tree structure. In the present disclosure, the key value refers to information including a key and a value corresponding to data, and may refer to information that may identify and access specific data in the memory 1200 of the computing device 1000. A detailed process for acquiring the data structure by the computing device 1000 in operation S100 will be described in detail below with reference to FIG. 3.

In operation S200, the computing device 1000 may perform a first computation of searching for first data corresponding to a first key value and a first time point included in the tree structure acquired in operation S100. In the present disclosure, the time point may mean a time at which an arbitrary operation performed by the computing device 1000 is started. Further, the searching for data may mean an operation in which the computing device 1000 visits a leaf node through a branch node from a root node in order to find a node including information in which data is stored in the data structure, and checks whether there is information corresponding to the data desired to be found. The searching for data may correspond to searching for a node including information corresponding to the data.

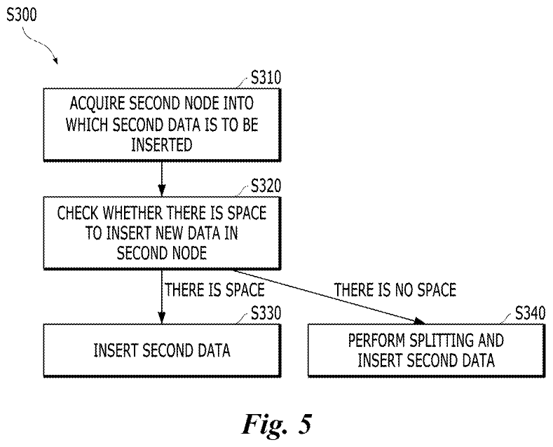

In operation S300, the computing device 1000 may perform a second computation of inserting a second key value and a second data address corresponding to second data into a second node of the tree structure. In the present disclosure, the data address may mean a physical location where data is actually stored in the memory 1200 of the computing device 1000. In the present disclosure, the second node may mean a node into which the second key value and the second data address are inserted in the second computation. In addition, in the present disclosure, the insertion of arbitrary data or information corresponding to data means that a node into which data is to be inserted is determined through a process of searching for a node into which data is to be inserted, and the data corresponding to the determined node or the information corresponding to the data is stored (recorded). A detailed process in which the computing device 1000 performs the second computation of inserting data and the like in operation S300 will be described in detail below with reference to FIG. 5.

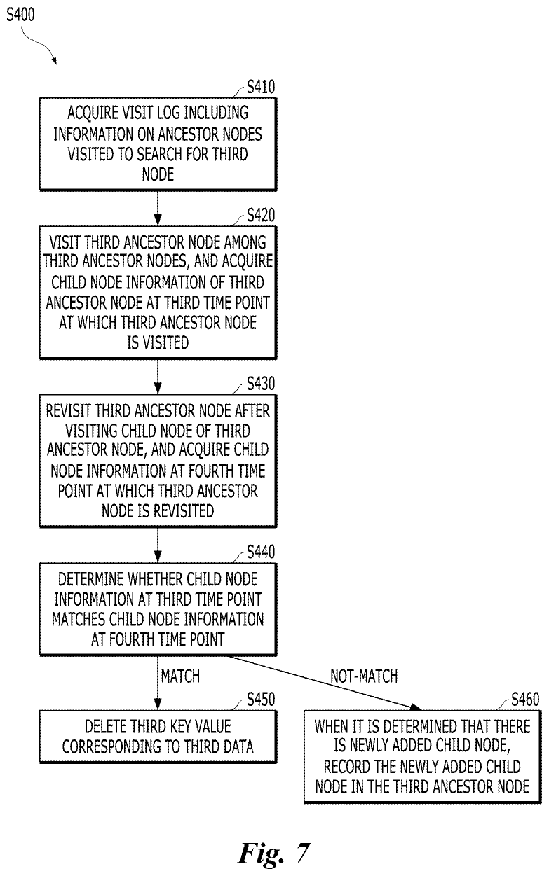

In operation S400, the computing device 1000 may perform a third computation of deleting a third key value and a third data address corresponding to third data from a third node of the tree structure. In the present disclosure, the third node may mean a node including the third key value and the third data address corresponding to the third data to be deleted in the third computation. In addition, in the present disclosure, the deletion of arbitrary data or information corresponding to data may mean that a node from which data is to be deleted is determined through a process of searching for a node from which data is to be deleted, and data corresponding to the determined node or information corresponding to the data is deleted. A detailed process in which the computing device 1000 performs the third computation of deleting data and the like in operation S400 will be described in detail below with reference to FIG. 7.

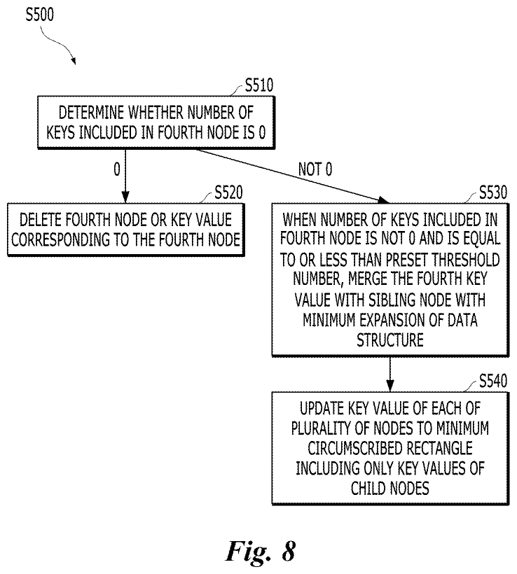

In operation S500, when a range of key values included in a fourth node is equal to or less than a preset threshold range, or when the number of keys included in the fourth node is equal to or less than a preset threshold number, the computing device 1000 may perform a fourth computation of removing the fourth node or merging the fourth node with another node. In the present disclosure, the threshold range and the threshold number may mean a range of arbitrary data and the number of keys set by the user of the computing device 1000 for each node. Specifically, the threshold range and the threshold number may be the minimum range and the minimum number that may be included in a node, and may be values smaller than the maximum range and the maximum number that each node may include. In addition, the merging of the nodes in the present disclosure may mean determining a node requiring a merging and a sibling node to be merged through a process of searching for a node requiring a merging operation, and moving data included in the determined node requiring the merging to the sibling node. A detailed process in which the computing device 1000 performs the fourth computation in operation S500 will be described in detail below with reference to FIG. 8.

In the example embodiment, the computing device 1000 may acquire an individual lock for a node to be visited while performing operations S100, S200, S300, S400, and S500. In the present disclosure, acquiring the lock may mean that an operation by another user or other operation cannot be performed on a locked node. In addition, the computing device 1000 may release an individual lock acquired after updating and/or expanding the key value and/or the data structure of the visited node. The updating and/or the expanding of the data structure by the computing device 1000 may mean that when new data or a node is generated or deleted in the data structure by the computation operation performed by the computing device 1000, or changes occur in key values or data included in the node, the range of the key value and/or data structure included in the data structure may be changed or expanded, and the content corresponding to the change or the expansion may be recorded or applied.

The updating and/or the expanding of the key value and/or the data structure of the node may mean that when the computing device 1000 inserts, deletes, or modifies (including merging, splitting, and the like) data or nodes, the generated, deleted, or modified (changed) key value may be updated and the range of the data structure including the updated key value may be expanded, reduced, or deleted.

In the example embodiment, when the computing device 1000 inserts arbitrary data into the data structure, a key value may be changed by the inserted data and/or the range of the data structure including the inserted data may be expanded. The computing device 1000 records the changed key value and/or the range of the expanded data structure in information for each node, newly records information for each node of a parent node of the node including the inserted data in response thereto, and when the key value of another ancestor node included in the tree structure and/or the data structure of the parent node is changed or expanded by the inserted data or the expanded range of the data structure, the computing device 1000 may record the changed key value and/or the expanded range of the data structure corresponding to the change or the expansion may be recorded in the ancestor node.

A database management system (DBMS) is a system for persistently storing data, and the system may experience a situation of simultaneous access to the same resource (data). In this case, the corresponding data may be corrupted by modification or deletion according to two or more accesses. In order to prevent contamination of such data, it is beneficial to maintain data consistency and integrity. The lock may be used as a method to ensure the consistency and integrity of the data. The lock may mean temporarily suspending changes to data in order to ensure the sequencing of transaction processing.

According to the example embodiment of the present disclosure, lock management may be performed in an efficient manner in a situation where a plurality of queries is processed by taking the lock in a specific node unit rather than taking the lock for the entire tree structure.

A specific process for the computing device 1000 to take a lock will be described in detail below with reference to FIGS. 3 to 9.

FIG. 3 is a diagram illustrating an example of an operation of acquiring the data structure for indexing data according to some example embodiments of the present disclosure.

Referring to FIG. 3, the computing device 1000 may acquire the data structure in which data included in a two-dimensional space is collected in a range of a variable size. In the example embodiment, the data structure may refer to any type of data structure representing a key value and/or a range of key values. For example, the data structure may be a Minimum Bounding Rectangle (MBR) including only a minimum range of a data range included in the data structure. As another example, the data structure may include a range equal to or greater than the minimum range of the data range.

In the example embodiment, the data structure includes a first data structure corresponding to a first upper node among the plurality of nodes and a second data structure corresponding to at least one second lower node of among lower nodes included in the first upper node. In addition, in the data structure, the range of the first data structure may include a part of the range of the second data structure instead of the whole. In addition, the data structure may include key values included in the nodes collected in the data structure.

In the example embodiment, the computing device 1000 may acquire key value A 111 and/or B 112 corresponding to arbitrary data. The computing device 1000 may acquire a data structure of a new range including key value A 111 and/or B 112 and key value N 110 corresponding to the corresponding data structure. In addition, the computing device 1000 may acquire another new data structure including key value N 110 and key value T 100 corresponding to the corresponding data structure.

The range of key values of the nodes illustrated in FIG. 3 may be exemplarily expressed in the form of a quadrangle. The wider the quadrangle is, the larger the range of key values is. As an example, the node N 110 may have an MBR range including the minimum range of key values A 111 and B 112 that are sub-nodes. As an example, node P may encompass all the ranges of key values of sub-nodes C, D, and E, but may include only part of the range of sub-node F.

In the example embodiment, the first data structure corresponding to the first upper node may include T 100, and the second data structure corresponding to the second lower node may include N 100.

The computing device 1000 may acquire a tree structure according to the inclusion relationship of nodes corresponding to the acquired data structures. The tree structure may mean a typical tree structure used in a database-related field, and may include a node corresponding to at least one of parent, child, root, branch, and leaf. For example, among the nodes illustrated in FIG. 3, T and U 100 may correspond to root nodes, N, P, Q 110, R, and S may correspond to branch nodes, and A 111, B 112 to M may correspond to leaf nodes.

FIG. 4 is a diagram illustrating an example of an operation of indexing data according to some example embodiments of the present disclosure.

Referring to FIG. 4, the computing device 1000 may include at least one of a node 1 10, a node 2 20, a node 3 30, a node 4 40, and a leaf node 50. The node 1 10 may be a root node and include the node 2 20 as a child, and the node 2 20 may be a branch node and include the node 3 30 and the node 4 40 as child nodes. In addition, the node 3 30 and the node 4 40 may be branch nodes, and may include the leaf node 50 as a child node. Also, the nodes including the child nodes may become parent nodes, and the child nodes having the same parent node may be referred to as sibling nodes.

Detailed descriptions of the nodes 1 10 to 4 40 and the leaf node 50 will be described in detail below with reference to FIGS. 5 to 9.

FIG. 5 is a flowchart of an example of a method of indexing data by the computing device according to some example embodiments of the present disclosure.

Referring to FIG. 5, in operations S300 and S310, the computing device 1000 may acquire a second node into which second data is to be inserted. The second node may be a leaf node that satisfies a condition that, when the computing device 1000 inserts the second data, key values of ancestor nodes to be modified are not changed or the range of key values is minimally changed.

The computing device 1000 may assume that second data is inserted into the second node for each of the ancestor nodes that should be passed to visit the second node, and modify key values of the ancestor nodes at the time point at which the ancestor nodes are visited. Specifically, for each of the ancestor nodes that should be passed to visit the second node, the computing device 1000 may acquire an individual lock on the ancestor node, for example, the first ancestor node, corresponding to the visit time point. Then, the computing device 1000 modifies the key value for the first ancestor node on an assumption that the second key value corresponding to the second data is to be inserted into the second node, and after the modification of the key value for the first ancestor node is completed, the computing device 1000 may release the lock acquired for the first ancestor node. In addition, the computing device 1000 may record (store) the time point of modifying the key value in information for each node, and record visit logs for visited nodes in the corresponding node and/or in a separate memory 1200 space (which may be a memory space included in another computing device).

In the present disclosure, the information for each node may include at least one of child node information acquired or updated while the computing device 1000 performs at least one of the first to fourth computations corresponding to operations S200, S300, S400, and S500, and a start time of the computation, and a final modification time. In addition, when the computing device 1000 performs a split operation, the information for each node may include at least one of an address of a node, a key value, and the number of times of the split generated by the split operation. In addition, the information for each node may be recorded in a node corresponding to the information for each node.

In the present disclosure, the visit log may include all nodes visited while the computing device 1000 performs at least one of the first to fourth computations corresponding to operations S200, S300, S400, and S500, and parent-child information between the nodes. In addition, the visit log may be recorded and managed in a range of a memory 1200 separate from the range of the memory 1200 including the node or in a memory included in a separate server.

In operation S320, the computing device 1000 checks whether there is a space in the second node to insert new data.

In operation S330, when there is the space to insert the second data in the second node, the computing device 1000 inserts the second data. Specifically, according to the example embodiment, the computing device 1000 may acquire a second time point, which is the time point for searching the tree structure in order to insert the second data into the second node. Then, the computing device 1000 acquires a final modification time of the second node based on the information for each node corresponding to the second node, and compares the second time point with the final modification time of the second node, and when the final modification time of the second node is more recent, the computing device 1000 may re-execute the process of searching the tree structure and update a time point of the re-execution as a new second time point. Then, the computing device 1000 compares the second time point with the final modification time of the second node, and when the second time point is more recent, the computing device 1000 may insert a second key value corresponding to the second data into the second node, and update the final modification time of the second node to the corresponding time point.

In operation S340, when there is no space to insert new data into the second node, the computing device 1000 may perform the split operation and insert the second data into the split node. In the example embodiment, referring to FIG. 4, the split operation may mean an operation in which when the space for inserting data including the key value of the leaf node 50 in the node 3 30 is insufficient, the computing device 1000 generates a new child node, the node 4 40, from the node 2 20, which is the parent node of the node 3 30, and including the key value of the leaf node 50 in the node 4 40.

The computing device 1000 may record addresses of the nodes visited while performing operation S300 and the number of times of the split of each node in information for each node, the visit log, or a separate log. In addition, when splitting actually occurs with respect to a certain node, the computing device 1000 may quickly visit and modify nodes requiring modification by referring to the recorded addresses of visited nodes and the number of times of the split.

In the example embodiment, referring to FIG. 4, in order to acquire a second node into which the second data is to be inserted in operation S310, the computing device 1000 may search for the leaf node 50 by visiting the node 1 10, the node 2 20, and the node 3 30. Assume that the second data is inserted into the leaf node 50 into the node 1 10 to the node 3 30 visited during the search process, the computing device 1000 may acquire the lock at the time of visiting each node, modify the key value corresponding to the node to which the second data is inserted, record the time point at which the key value is modified, and release the lock. In addition, the computing device 1000 may record information on the node 1 10 to the node 3 30 visited to search for the leaf node 50 in the visit log.

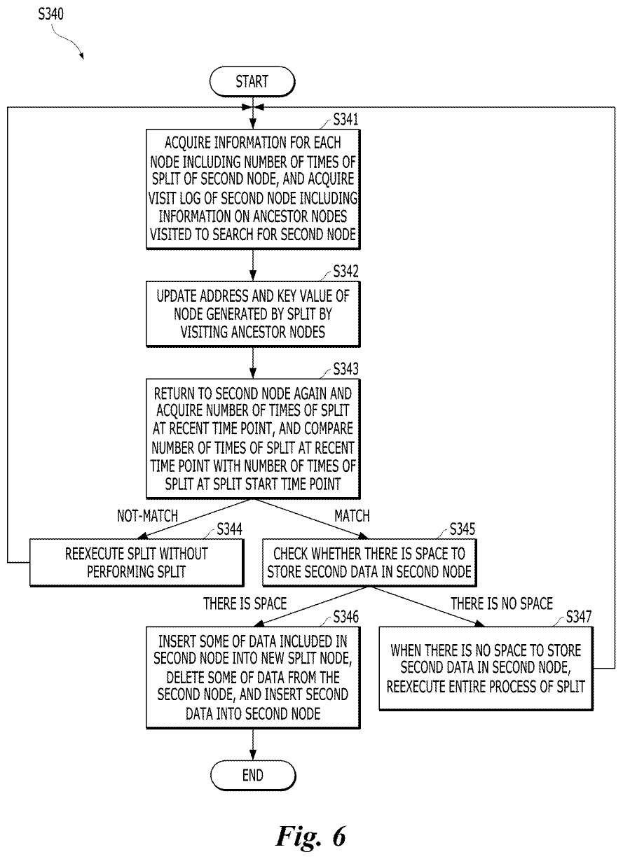

In operation S320, the computing device 1000 checks whether there is a space to insert the second data in the leaf node 50, which is the second node, and when there is the space, the computing device 1000 may insert the second data into the leaf node 50 in operation S330. When there is no space to insert the second data in the leaf node 50, the computing device 1000 may perform a split operation. A detailed method for the computing device 1000 to perform the split operation will be described in detail below with reference to FIG. 6.

FIG. 6 is a flowchart of an example of a method of indexing data by a computing device according to some example embodiments of the present disclosure.

Referring to FIG. 6, referring to FIG. 5, when the split operation is performed in operation S340, in operation S341, the computing device 1000 may acquires information for each node including the number of times of the split of the second node, and acquire a visit log of the second node including information on ancestor nodes visited to search for the second node.

In operation S342, the computing device 1000 may acquire information on the ancestor nodes visited in the process of searching for the second node by referring to the visit log acquired in operation S341, and visit the ancestor nodes and update the address and the key value of the node generated by the splitting. In addition, the computing device 1000 may acquire an individual lock for the parent node of the second node at the time of visiting the parent node of the second node.

In operation S343, the computing device 1000 may return to the second node to acquire the number of times of the splits of the second node at the latest time point and compare the acquired number of times of the split of the second node at the latest time point with the number of times of the split of the second node at the start time point of the split operation. Specifically, the computing device 1000 acquires the first number of times of the split based on the node-specific information of the parent node at the start time point of the split operation, acquires the second number of times of the split at the time of visiting the parent node, and compare the first number of times of the split with the second number of times of the split.

In operation S344, when the first number of times of the split and the second number of times of the split compared in operation S343 do not match, and/or when the second node is used by another user or other operations and is locked, the computing device 1000 may re-execute the split operation from operation S341 without performing the split.

In operation S345, when the first number of times of the split and the second number of times of the split compared in operation S343 match, the computing device 1000 may determine whether there is a space in the second node to store the second data.

In operation S346, when there is the space to store the second data in the second node in operation S345, the computing device 1000 may perform the split, insert some of the data included in the second node into the new split node, delete data duplicated with the data inserted into the new node in the second node, and insert the second data into the second node. In addition, the computing device 1000 may insert a new key value according to the result of performing the split into the parent node of the second node and release the acquired individual lock. The split operation may be sequentially performed on one or more nodes until a time point at which the second node into which the second data is inserted is acquired.

In operation S347, when there is no space to store the second data in the second node in operation S345, the computing device 1000 may re-execute the split operation from operation S341.

In the example embodiment, referring to FIG. 4, assuming that the leaf node 50 is data corresponding to the second data and the node 3 30 is the second node, when there is no space to insert the leaf node 50 in node 3 30, the computing device 1000 may generate the node 4 40, which is a child node of node 2 20 that is a parent node of node 3 30, and the sibling node of the node 3 30, and insert some data included in the node 3 30 into the node 4 40. In addition, the computing device 1000 may delete the data duplicated with the node 4 40 from the node 3 30 and insert data corresponding to the leaf node 50 into the node 3 30.

FIG. 7 is a flowchart of an example of a method of indexing data by a computing device according to some example embodiments of the present disclosure.

Referring to FIG. 7 and referring to FIG. 2, when a third computation is performed in operation S400, in operation S410, the computing device 1000 may acquire a visit log including information on the ancestor nodes visited to search for the third node.

In operation S420, the computing device 1000 may visit a third ancestor node among the ancestor nodes of the third node and acquire child node information of the third ancestor node at a third time point when the third ancestor node is visited. In addition, the computing device 1000 may acquire and maintain the lock while visiting the third ancestor node and acquiring child node information of the third ancestor node. The third ancestor node may be a parent node of the third node including the third node as a child among the branch nodes of the tree structure. In addition, when visiting the ancestor nodes of the third node, the computing device 1000 may record whether the child nodes are visited in each ancestor node.

In operation S430, the computing device 1000 may visit all child nodes included in the third ancestor node, revisit the third ancestor node, and acquire the child node information at a fourth time point when the third ancestor node is revisited.

In operation S440, the computing device 1000 may determine whether the child node information at the third time point matches the child node information at the fourth time point.

In operation S450, when the child node information at the third time point matches the child node information at the fourth time point in operation S440, the computing device 1000 may delete the third key value corresponding to the third data.

In operation S460, when the child node information at the third time point does not match the child node information at the fourth time point in operation S440, and when it is determined that there is a newly added child node, the computing device 1000 may record the newly added child node in the third ancestor node. In addition, the computing device 1000 may maintain the lock from a time of visiting a node in which the newly added node is to be recorded to a time in which the newly added node is recorded.

In the example embodiment, referring to FIG. 4, the computing device 1000 may acquire information for each node by acquiring a lock on the corresponding node at the time of visiting each node for all nodes visited to search for the third node of the latest time point and release the lock. In addition, the computing device 1000 may store information on the child nodes of each of all nodes visited through the information for each node in a separate memory 1200 space. Specifically, the computing device 1000 may visit the node 2 20 and confirm that only the node 3 30 (including the leaf node 50 that is the third node) is present as the child node of the node 2 20 through the information for each node. After visiting all parent nodes and acquiring the child node information, the computing device 1000 may recursively revisit all visited parent nodes through the visit log. Then, the computing device 1000 checks whether the child nodes included in each recorded parent node match the child nodes included in the parent node at the time of the revisit. For example, in the node 2 20, the node 4 40, which is a new child node, may be generated, and the leaf node 50 corresponding to the third node may be relocated to the node 4 40. In this case, the computing device 1000 may add the node 4 40 as a child node of the node 2 20 to information in which the child nodes of the visited nodes are recorded. Then, the computing device 1000 may confirm that the third node has been removed at the time of revisiting the node 3 30, search for the node 4 40 through the information in which the child nodes of the nodes are recorded, and search for the third node at the latest time point.

FIG. 8 is a flowchart of an example of the method of indexing data by the computing device according to some example embodiments of the present disclosure.

Referring to FIG. 8 and referring to FIG. 2, when the fourth computation is performed in operation S500, in operation S510, the computing device 1000 may check whether the number of keys included in the fourth node is 0.

In operation S520, when the number of keys included in the fourth node is 0 in operation S510, the computing device 1000 may remove the fourth node or a key value corresponding to the fourth node.

In operation S530, when the number of keys included in the fourth node is not 0 and equal to or less than a preset threshold number in operation S510, the computing device 1000 may merge the fourth key value to a sibling node in which the expansion of the data structure is reduced or minimized.

In operation S540, the computing device 1000 may update the key value of each of the plurality of nodes to a minimum circumscribed rectangle including only the key values of the child nodes. Specifically, the computing device 1000 acquires the lock of the fourth node and the parent node of the fourth node, and when the range of key values of the fourth node is compared with the range of key values of the parent node of the fourth node and the criterion of the minimum circumscribed rectangle is not satisfied, the computing device 1000 may update the key values of at least one of the fourth node and the parent node so that the range of key values of the corresponding fourth node and the parent node satisfies the criterion of a minimum circumscribed rectangle. Further, after updating the key values, the computing device 1000 may release the locks acquired for the fourth node and the parent node of the fourth node.

In the example embodiment, referring to FIG. 4, the computing device 1000 may acquire a lock of the node 3 30, and when there is no data included in the node 3 30 (when the number of included keys is 0), the computing device 1000 may acquire a lock of the node 2 20 and remove the key value for the node 3 30 from the node 2 20. In addition, the computing device 1000 may release the locks on the node 2 20 and the node 3 30 and check whether the data included in the next node is equal to or less than a threshold number and/or a threshold range.

In another example embodiment, when the computing device 1000 acquires a lock of the node 3 30 and the data included in the node 3 30 is equal to or less than the threshold number and/or the threshold range, and acquires the lock of the node 2 20 and includes the key value included in the node 3 30, the computing device 1000 may acquire the lock of the node 4 40 in which the expansion of the data structure is reduced or minimized, and relocate the key value and the address of the data included in the node 3 30 to the node 4 40. In addition, the computing device 1000 may update the changed information (size of the data structure or the key value, and the like) of the node 3 30 and the node 4 40 in the node 2 20.

In another example embodiment, the computing device 1000 may acquire the lock of the node 3 30, and acquire the data structure including the key values included in the node 3 30 as a data structure having a minimum contiguous rectangle. Then, the computing device 1000 may compare the data structure of the node 2 20 with the data structure of the node 3 30, and when the data structure of the node 3 30 is smaller, the computing device 1000 may acquire a lock on the node 2 20, update a key value corresponding to the data structure of the node 3 30, and update the data structure of the node 2 20.

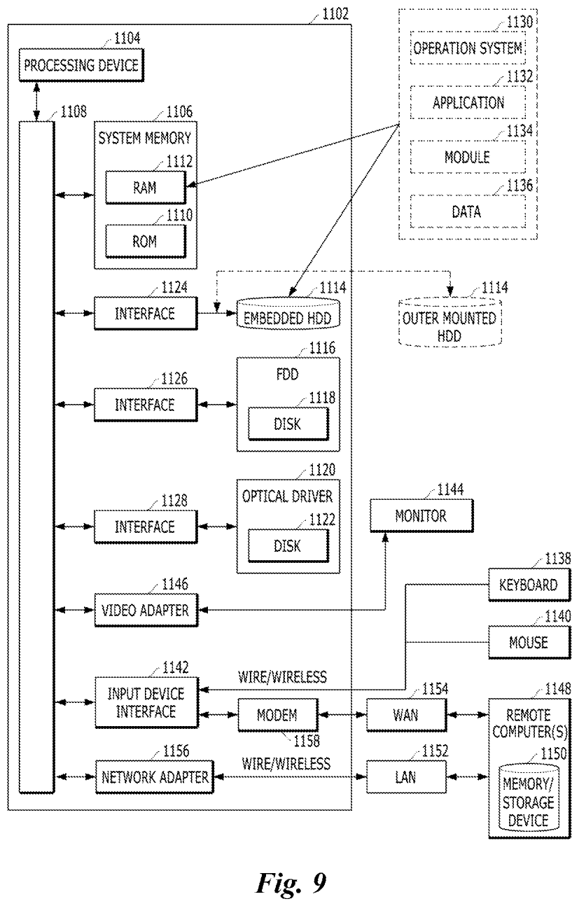

FIG. 9 is a simple and general schematic diagram illustrating an example of a computing environment in which the example embodiments of the present disclosure are implementable.

The present disclosure has been described as being generally implementable by the computing device, but those skilled in the art will appreciate well that the present disclosure is combined with computer executable commands and/or other program modules executable in one or more computers and/or be implemented by a combination of hardware and software.

In general, a program module includes a routine, a program, a component, a data structure, and the like performing a specific task or implementing a specific abstract data form. Further, those skilled in the art will well appreciate that the method of the present disclosure may be carried out by a personal computer, a hand-held computing device, a microprocessor-based or programmable home appliance (each of which may be connected with one or more relevant devices and be operated), and other computer system configurations, as well as a single-processor or multiprocessor computer system, a mini computer, and a main frame computer.

The example embodiments of the present disclosure may be carried out in a distribution computing environment, in which certain tasks are performed by remote processing devices connected through a communication network. In the distribution computing environment, a program module may be located in both a local memory storage device and a remote memory storage device.

The computer generally includes various computer readable media. The computer accessible medium may be any type of computer readable medium, and the computer readable medium includes volatile and non-volatile media, transitory and non-transitory media, and portable and non-portable media. As a non-limited example, the computer readable medium may include a computer readable storage medium and a computer readable transmission medium. The computer readable storage medium includes volatile and non-volatile media, transitory and non-transitory media, and portable and non-portable media constructed by a predetermined method or technology, which stores information, such as a computer readable command, a data structure, a program module, or other data. The computer readable storage medium includes a RAM, a Read Only Memory (ROM), an Electrically Erasable and Programmable ROM (EEPROM), a flash memory, or other memory technologies, a Compact Disc (CD)-ROM, a Digital Video Disk (DVD), or other optical disk storage devices, a magnetic cassette, a magnetic tape, a magnetic disk storage device, or other magnetic storage device, or other predetermined media, which are accessible by a computer and are used for storing desired information, but is not limited thereto.

The computer readable transport medium generally implements a computer readable command, a data structure, a program module, or other data in a modulated data signal, such as a carrier wave or other transport mechanisms, and includes all of the information transport media. The modulated data signal means a signal, of which one or more of the characteristics are set or changed so as to encode information within the signal. As a non-limited example, the computer readable transport medium includes a wired medium, such as a wired network or a direct-wired connection, and a wireless medium, such as sound, Radio Frequency (RF), infrared rays, and other wireless media. A combination of the predetermined media among the foregoing media is also included in a range of the computer readable transport medium.

An illustrative environment 1100 including a computer 1102 and implementing several aspects of the present disclosure is illustrated, and the computer 1102 includes a processing device 1104, a system memory 1106, and a system bus 1108. The system bus 1108 connects system components including the system memory 1106 (not limited) to the processing device 1104. The processing device 1104 may be a predetermined processor among various commonly used processors. A dual processor and other multi-processor architectures may also be used as the processing device 1104.

The system bus 1108 may be a predetermined one among several types of bus structure, which may be additionally connectable to a local bus using a predetermined one among a memory bus, a peripheral device bus, and various common bus architectures. The system memory 1106 includes a ROM 1110, and a RAM 1112. A basic input/output system (BIOS) is stored in a non-volatile memory 1110, such as a ROM, an EPROM, and an EEPROM, and the BIOS includes a basic routing helping a transport of information among the constituent elements within the computer 1102 at a time, such as starting. The RAM 1112 may also include a high-rate RAM, such as a static RAM, for caching data.

The computer 1102 also includes an embedded hard disk drive (HDD) 1114 (for example, enhanced integrated drive electronics (EIDE) and serial advanced technology attachment (SATA))—the embedded HDD 1114 being configured for exterior mounted usage within a proper chassis (not illustrated)—a magnetic floppy disk drive (FDD) 1116 (for example, which is for reading data from a portable diskette 1118 or recording data in the portable diskette 1118), and an optical disk drive 1120 (for example, which is for reading a CD-ROM disk 1122, or reading data from other high-capacity optical media, such as a DVD, or recording data in the high-capacity optical media). A hard disk drive 1114, a magnetic disk drive 1116, and an optical disk drive 1120 may be connected to a system bus 1108 by a hard disk drive interface 1124, a magnetic disk drive interface 1126, and an optical drive interface 1128, respectively. An interface 1124 for implementing an exterior mounted drive includes, for example, at least one of or both a universal serial bus (USB) and the Institute of Electrical and Electronics Engineers (IEEE) 1394 interface technology.

The drives and the computer readable media associated with the drives provide non-volatile storage of data, data structures, computer executable commands, and the like. In the case of the computer 1102, the drive and the medium correspond to the storage of random data in an appropriate digital form. In the description of the computer readable media, the HDD, the portable magnetic disk, and the portable optical media, such as a CD, or a DVD, are mentioned, but those skilled in the art will well appreciate that other types of computer readable media, such as a zip drive, a magnetic cassette, a flash memory card, and a cartridge, may also be used in the illustrative operation environment, and the predetermined medium may include computer executable commands for performing the methods of the present disclosure.

A plurality of program modules including an operation system 1130, one or more application programs 1132, other program modules 1134, and program data 1136 may be stored in the drive and the RAM 1112. An entirety or a part of the operation system, the application, the module, and/or data may also be cached in the RAM 1112. It will be well appreciated that the present disclosure may be implemented by several commercially usable operation systems or a combination of operation systems.

A user may input a command and information to the computer 1102 through one or more wired/wireless input devices, for example, a keyboard 1138 and a pointing device, such as a mouse 1140. Other input devices (not illustrated) may be a microphone, an IR remote controller, a joystick, a game pad, a stylus pen, a touch screen, and the like. The foregoing and other input devices are frequently connected to the processing device 1104 through an input device interface 1142 connected to the system bus 1108, but may be connected by other interfaces, such as a parallel port, an IEEE 1394 serial port, a game port, a USB port, an IR interface, and other interfaces.

A monitor 1144 or other types of display devices are also connected to the system bus 1108 through an interface, such as a video adaptor 1146. In addition to the monitor 1144, the computer generally includes other peripheral output devices (not illustrated), such as a speaker and a printer.

The computer 1102 may be operated in a networked environment by using a logical connection to one or more remote computers, such as remote computer(s) 1148, through wired and/or wireless communication. The remote computer(s) 1148 may be a work station, a computing device computer, a router, a personal computer, a portable computer, a microprocessor-based entertainment device, a peer device, and other general network nodes, and generally includes some or an entirety of the constituent elements described for the computer 1102, but only a memory storage device 1150 is illustrated for simplicity. The illustrated logical connection includes a wired/wireless connection to a local area network (LAN) 1152 and/or a larger network, for example, a wide area network (WAN) 1154. The LAN and WAN networking environments are general in an office and a company, and make an enterprise-wide computer network, such as an Intranet, easy, and all of the LAN and WAN networking environments may be connected to a worldwide computer network, for example, the Internet.

When the computer 1102 is used in the LAN networking environment, the computer 1102 is connected to the local network 1152 through a wired and/or wireless communication network interface or an adaptor 1156. The adaptor 1156 may make wired or wireless communication to the LAN 1152 easy, and the LAN 1152 also includes a wireless access point installed therein for the communication with the wireless adaptor 1156. When the computer 1102 is used in the WAN networking environment, the computer 1102 may include a modem 1158, is connected to a communication computing device on a WAN 1154, or includes other means setting communication through the WAN 1154 via the Internet. The modem 1158, which may be an embedded or outer-mounted and wired or wireless device, is connected to the system bus 1108 through a serial port interface 1142. In the networked environment, the program modules described for the computer 1102 or some of the program modules may be stored in a remote memory/storage device 1150. The illustrated network connection is illustrative, and those skilled in the art will appreciate well that other means setting a communication link between the computers may be used.

The computer 1102 performs an operation of communicating with a predetermined wireless device or entity, for example, a printer, a scanner, a desktop and/or portable computer, a portable data assistant (PDA), a communication satellite, predetermined equipment or place related to a wirelessly detectable tag, and a telephone, which is disposed by wireless communication and is operated. The operation includes a wireless fidelity (Wi-Fi) and Bluetooth wireless technology at least. Accordingly, the communication may have a pre-defined structure, such as a network in the related art, or may be simply ad hoc communication between at least two devices.

The Wi-Fi enables a connection to the Internet and the like even without a wire. The Wi-Fi is a wireless technology, such as a cellular phone, which enables the device, for example, the computer, to transmit and receive data indoors and outdoors, that is, in any place within a communication range of a base station. A Wi-Fi network uses a wireless technology, which is called IEEE 802.11 (a, b, g, etc.) for providing a safe, reliable, and high-rate wireless connection. The Wi-Fi may be used for connecting the computer to the computer, the Internet, and the wired network (IEEE 802.3 or Ethernet is used). The Wi-Fi network may be operated at, for example, a data rate of 11 Mbps (802.11a) or 54 Mbps (802.11b) in an unauthorized 2.4 and 5 GHz wireless band, or may be operated in a product including both bands (dual bands).

Those skilled in the art may appreciate that information and signals may be expressed by using predetermined various different technologies and techniques. For example, data, indications, commands, information, signals, bits, symbols, and chips referable in the foregoing description may be expressed with voltages, currents, electromagnetic waves, magnetic fields or particles, optical fields or particles, or a predetermined combination thereof.

Those skilled in the art will appreciate that the various illustrative logical blocks, modules, processors, means, circuits, and algorithm operations described in relationship to the example embodiments disclosed herein may be implemented by electronic hardware (for convenience, called “software” herein), various forms of program or design code, or a combination thereof In order to clearly describe compatibility of the hardware and the software, various illustrative components, blocks, modules, circuits, and operations are generally illustrated above in relation to the functions of the hardware and the software. Whether the function is implemented as hardware or software depends on design limits given to a specific application or an entire system. Those skilled in the art may perform the function described by various schemes for each specific application, but it shall not be construed that the determinations of the performance depart from the scope of the present disclosure.

Various example embodiments presented herein may be implemented by a method, a device, or a manufactured article using a standard programming and/or engineering technology. A term “manufactured article” includes a computer program, a carrier, or a medium accessible from a predetermined computer-readable storage device. For example, the computer-readable storage medium includes a magnetic storage device (for example, a hard disk, a floppy disk, and a magnetic strip), an optical disk (for example, a CD and a DVD), a smart card, and a flash memory device (for example, an EEPROM, a card, a stick, and a key drive), but is not limited thereto. Further, various storage media presented herein include one or more devices and/or other machine-readable media for storing information.

It shall be understood that a specific order or a hierarchical structure of the operations included in the presented processes is an example of illustrative accesses. It shall be understood that a specific order or a hierarchical structure of the operations included in the processes may be rearranged within the scope of the present disclosure based on design priorities. The accompanying method claims provide various operations of elements in a sample order, but it does not mean that the claims are limited to the presented specific order or hierarchical structure.

The description of the presented example embodiments is provided so as for those skilled in the art to use or carry out the present disclosure. Various modifications of the example embodiments may be apparent to those skilled in the art, and general principles defined herein may be applied to other example embodiments without departing from the scope of the present disclosure. Accordingly, the present disclosure is not limited to the example embodiments suggested herein, and shall be interpreted within the broadest meaning range consistent to the principles and new characteristics presented herein.

The various embodiments described above can be combined to provide further embodiments. All of the U.S. patents, U.S. patent application publications, U.S. patent applications, foreign patents, foreign patent applications and non-patent publications referred to in this specification and/or listed in the Application Data Sheet are incorporated herein by reference, in their entirety. Aspects of the embodiments can be modified, if necessary to employ concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A data indexing method performed by a computing device including one or more processors, the data indexing method comprising:
acquiring data structures of a variable size that defines a range of key values of a plurality of nodes included in a tree structure, the data structure of one variable size corresponding to one node; and
acquiring a lock for some nodes of the plurality of nodes included in the tree structure and performing a computation or a split operation.

2. The data indexing method of claim 1, wherein the data structure of the variable size includes a rectangular data structure including key values of child nodes or key values of data;
wherein the data structure includes a first data structure corresponding to a first upper node among the plurality of nodes and a second data structure corresponding to a second lower node of at least one of lower nodes included in the first upper node;
wherein a range of the first data structure includes a portion, but not all, of a range of the second data structure, and
wherein an individual lock for a branch node is acquired in the computation, and the individual lock is continued for a modification time for the branch node.

3. The data indexing method of claim 1, wherein the performing of the computation or the split operation on at last one node in the tree structure includes recording information for each node included in the tree structure into a corresponding node, and
wherein the information for each node includes at least one of child node information, a starting time and a final modification time of the computation when the operation is performed, and includes at least one of an address, a key value, and the number of times of the split of a node generated by the split operation when the split operation is performed.

4. The data indexing method of claim 1, wherein the acquiring of the lock for some nodes of the plurality of nodes and the performing of the computation or the split operation includes acquiring an individual lock of a node to be visited to perform the computation or the split operation, updating or extending a key value and a data structure of the visited node, and releasing the acquired individual lock.

5. The data indexing method of claim 1, wherein the acquiring of the lock for some nodes of the plurality of nodes and the performing of the computation or the split operation includes:
acquiring, from a memory, records of nodes visited to perform the computation or the split operation; and
acquiring a lock for some nodes of the plurality of nodes based on the records of the visited nodes, and performing a corresponding computation or a split operation.

6. The data indexing method of claim 1, wherein the computation includes at least one of:
a first computation of searching for a first data corresponding to a first key value and a first time point included in the tree structure;
a second computation of inserting a second key value and a second data address corresponding to second data into a second node of the tree structure;
a third computation of deleting a third key value and a third data address corresponding to third data from a third node of the tree structure; and
a fourth computation of, when a range of key values included in a fourth node is equal to or less than a preset threshold range or when the number of keys included in the fourth node is equal to or less than a preset threshold number, removing the fourth node or merging the fourth node to another node.

7. The data indexing method of claim 6, wherein the second computation includes, when a second key value corresponding to the second data is inserted, determining the second node that satisfies a condition in which key values of ancestor nodes to be modified are not changed or a condition in which a range of key values is changed to a minimum as a node into which the second key value is to be inserted.

8. The data indexing method of claim 6, wherein the second computation further includes:
for each of the ancestor nodes to go through to visit the second node, acquiring an individual lock for a first ancestor node to be visited among the ancestor nodes, and modifying a key value for the first ancestor node on the assumption that a second key value corresponding to the second data is to be inserted into the second node; and
releasing the lock acquired for the first ancestor node when the modification of the key value for the first ancestor node is completed.

9. The data indexing method of claim 6, wherein the second computation includes modifying a key value of a parent node of the second node before modifying a second key value of the second node that is a leaf node.

10. The data indexing method of claim 6, wherein the second computation includes:
acquiring a second time point, which is a time point at which searching of the tree structure starts to perform the second computation;
acquiring a final modification time of the second node based on information for each node corresponding to the second node;
comparing the second time point with the final modification time of the second node and re-executing the second computation when the final modification time is more recent; and
comparing the second time point and the final modification time of the second node, and when the second time point is more recent, inserting a second key value corresponding to the second data into the second node, and updating the final modification time of the second node to a corresponding time point.

11. The data indexing method of claim 6, wherein the second computation includes:
determining a second node into which a second key value corresponding to the second data is to be inserted;
checking whether there is a space for inserting a new value in the second node;
inserting the second key value into the second node when there is space in the second node to insert the new value; and
performing a split operation when the space for inserting the new value is insufficient in the second node, and inserting the second key value into the second node or a new node generated according to the split operation, and
wherein the split operation includes acquiring information for each node including the number of time so the split of the node and acquiring a visit log of the second node including information on ancestor nodes visited to search for the second node.

12. The data indexing method of claim 11, wherein the split operation further includes:
visiting a parent node of the second node based on the visit log and acquiring an individual lock for the visited parent node;
acquiring a first number of times of the split of the parent node at a start time point of the split operation based on the information for each node, acquiring a second number of times of the split recorded in the visited parent node, and comparing the first number of times of the split with the second number of times of the split;
when the first number of times of the split matches the second number of times of the split, performing splitting, inserting a new key value according to a result of the splitting into the parent node, and releasing the acquired individual lock; and
re-executing the split operation without performing the splitting when the first number of times of the split and the second number of times of the split do not match.

13. The data indexing method of claim 6, wherein the third computation includes:
acquiring a visit log including information on ancestor nodes visited to search for the third node;
visiting a third ancestor node among the ancestor nodes of the third node based on the visit log, and acquiring child node information of the third ancestor node at a third time point at which the third ancestor node is visited;
after visiting a child node of the third ancestor node, revisiting the third ancestor node and acquiring child node information at a fourth time point at which the third ancestor node is revisited; and
comparing the child node information at the third time point with the child node information at the fourth time point.

14. The data indexing method of claim 13, wherein the third computation further includes:
when the child node information at the third time point matches the child node information at the fourth time point, deleting a third key value corresponding to the third data; and
when the child node information at the third time point and the child node information at the fourth time point do not match and it is determined that a newly added child node exists, recording the newly added child node in the third ancestor node.

15. The data indexing method of claim 13, wherein in the third computation, an individual lock for the third ancestor node is acquired, and the individual lock for the third ancestor node is maintained while visiting the third ancestor node to acquire the child node information of the third ancestor node.

16. The data indexing method of claim 6, wherein the fourth computation includes at least one of:
removing the fourth node or a key value corresponding to the fourth node when the number of keys included in the fourth node is 0;
when the number of keys included in the fourth node is not 0 and is equal to or less than a preset threshold number, merging a fourth key value of the fourth node with a sibling node in which the expansion of the data structure is minimal, the sibling node being a sibling node of the fourth node; and
updating a key value of each of the plurality of nodes to a minimum circumscribed rectangle including only key values of child nodes.

17. The data indexing method of claim 16, wherein the removing of the fourth node or the key value corresponding to the fourth node when the number of keys included in the fourth node is 0 includes acquiring a lock for the fourth node and a parent node of the fourth node, removing a key value corresponding to the fourth node from the parent node of the fourth node, and releasing the acquired lock.

18. The data indexing method of claim 16, wherein the merging of the fourth key value of the fourth node with the sibling node in which an expansion of a data structure is minimal includes:
acquiring a lock of the fourth node and a parent node of the fourth node;
checking information for each node of the parent node of the fourth node, and when it is determined that key values of the fourth node are included in the parent node, selecting the sibling node in which the expansion of the data structure is minimized and acquiring a lock for the selected sibling node; and
releasing locks for the fourth node, the parent node of the fourth node, and the sibling node when the transfer of all key values of the fourth node to the sibling node is finished.

19. The data indexing method of claim 16, wherein the updating of the key value of each of the plurality of nodes to the minimum circumscribed rectangle including only the key values of the child nodes includes:
acquiring a lock of the fourth node and a parent node of the fourth node;
when the range of key values of the fourth node is compared with a range of key values of the parent node of the fourth node and a criterion of the minimum circumscribed rectangle is not satisfied, updating the key value of at least one of the fourth node and the parent node such that the corresponding range of the key values of the fourth node and the parent node satisfies a criterion of the minimum circumscribed rectangle; and
after updating the key values, releasing the locks acquired for the fourth node and the parent node of the fourth node.

20. A non-transitory computer readable medium including a computer program, the computer program causing at least one processor of a computing device to perform a data indexing method, the data indexing method comprising:
acquiring data structures of variable sizes defining a range of key values of a plurality of nodes included in a tree structure, one data structure of the variable size corresponding to one node; and
acquiring a lock on some nodes among the plurality of nodes included in the tree structure and performing a computation or a split operation.
